(19) United States
(12) Patent Application Publication
(10) Pub. No.: US 2009/0165004 A1
(43) Pub. Date: Jun. 25, 2009

(54) Resource-aware application scheduling

(76) Inventors: Jaideep Moses, Portland, OR (US); Don K. Newell, Portland, OR (US); Ramesh Illikkal, Portland, OR (US); Ravishankar Iyer, Portland, OR (US); Srihari Makineni, Portland, OR (US); Li Zhao, Beaverton, OR (US); Scott Hahn, Beaverton, OR (US); Tong N. Li, Portland, OR (US); Padmashree Apparao, Portland, OR (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/004,756

(22) Filed: Dec. 21, 2007

(51) Int. Cl. G06F 9/46

(52) U.S. Cl. 718/102

(57) ABSTRACT

In one embodiment, a method provides capturing resource monitoring information for a plurality of applications; accessing the resource monitoring information; and scheduling at least one of the plurality of applications on a selected processing core of a plurality of processing cores based, at least in part, on the resource monitoring information.

### FIELD

Embodiments of this invention relate to resource-aware application scheduling.

### BACKGROUND

Resource contention can impair the performance of applications, and may reduce overall system throughput. For example, in a multi-core architecture where multiple applications may execute simultaneously on a system, performance may be severely degraded when there is contention at a shared resource, such as a last level cache.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a system in accordance with embodiments of the invention.

FIG. 2 illustrates a method according to an embodiment of the invention.

FIG. 3 illustrates a system in accordance with embodiments of the invention.

FIG. 4 illustrates a table used in accordance with an embodiment of the invention.

### DETAILED DESCRIPTION

Examples described below are for illustrative purposes only, and are in no way intended to limit embodiments of the invention. Thus, where examples are described in detail, or where one or more examples are provided, it should be understood that the examples are not to be construed as exhaustive, and are not to be limited to embodiments of the invention to the examples described and/or illustrated.

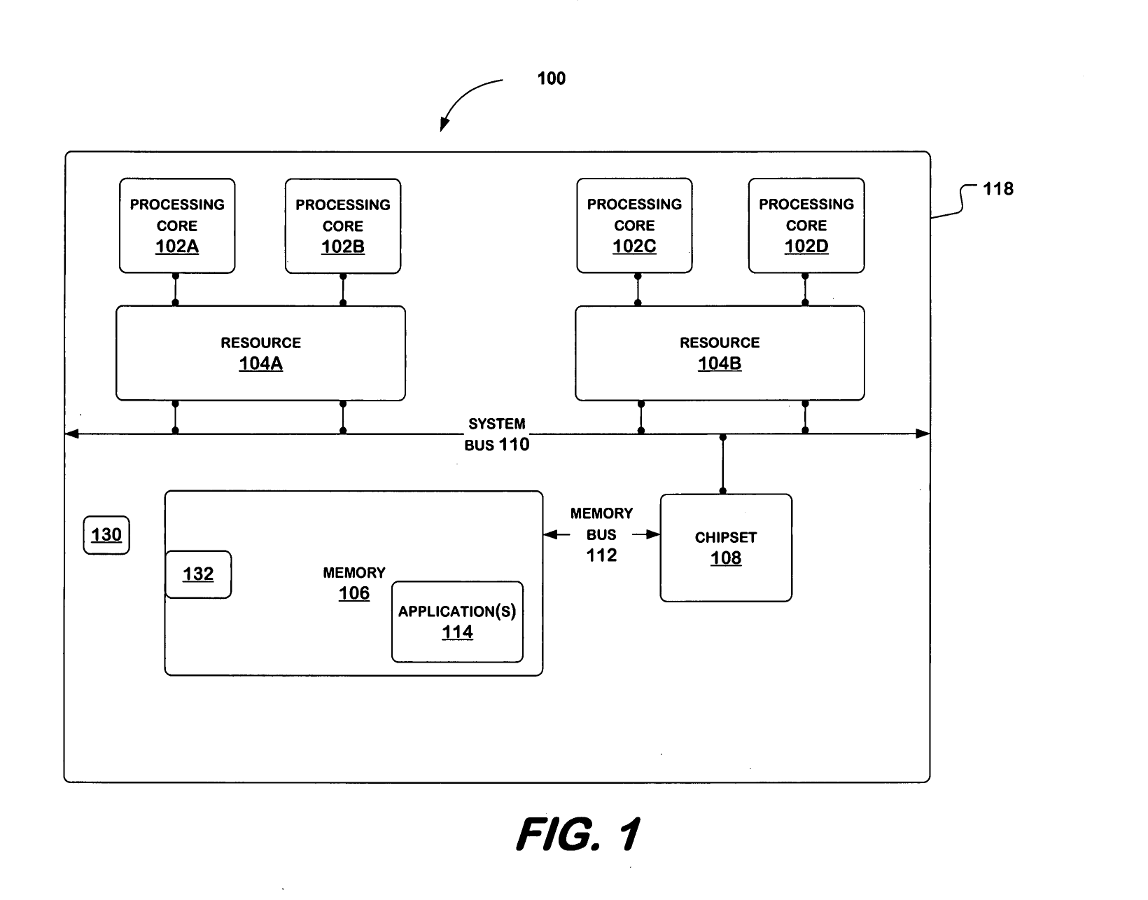

FIG. 1 is a block diagram that illustrates a computing system 100 according to an embodiment. In some embodiments, computing system 100 may comprise a plurality of processing cores 102A, 102B, 102C, 102D, and one or more shared resources 104A, 104B. In an embodiment, shared resources 104A, 104B may comprise shared caches, and in particular embodiments, may comprise shared last level caches. However, embodiments of the invention are not limited in this respect.

In an embodiment, processing cores 102A, 102B may reside on one processor die, and processing cores 102C, 102D may reside on another processor die. Embodiments, however, are not limited in this respect, and processing cores 102A, 102B, 102C, 102D may all reside on same processor die, or in other combinations. A “processor” as discussed herein relates to any combination of hardware and software resources for accomplishing computational tasks. For example, a processor may comprise a central processing unit (CPU) or microcontroller to execute machine-readable instructions for processing data according to a predefined instruction set. A processor may comprise a multi-core processor having a plurality of processing cores. A processor may alternative refer to a processing core that may be comprised in the multi-core processor, where an operating system may perceive the processing core as a discrete processor with a full set of execution resources. Other possibilities exist.

System 100 may additionally comprise memory 106. Memory 106 may store machine-executable instructions 132 that are capable of being executed, and/or data capable of being accessed, operated upon, and/or manipulated. “Machine-executable” instructions as referred to herein relate to expressions which may be understood by one or more machines for performing one or more logical operations. For example, machine-executable instructions 132 may comprise instructions which are interpretable by a processor compiler for executing one or more operations on one or more data objects. However, this is merely an example of machine-executable instructions and embodiments of the present invention are not limited in this respect. Memory 106 may additionally comprise one or more application(s) 114, which may be read from a storage device, such as a hard disk drive, or a non-volatile memory, such as a ROM (read-only memory), and stored in memory 106 for execution by one or more processing cores 102A, 102B, 102C, 102D. Memory 106 may, for example, comprise read only, mass storage, random access computer-accessible memory, and/or one or more other types of machine-accessible memories.

Logic 130 may be comprised on or within any part of system 100 (e.g., motherboard 118). Logic 130 may comprise hardware, software, or a combination of hardware and software (e.g., firmware). For example, logic 130 may comprise circuitry (i.e., one or more circuits), to perform operations described herein. For example, logic 130 may comprise one or more digital circuits, one or more analog circuits, one or more state machines, programmable logic, and/or one or more ASICs (Application-Specific Integrated Circuits). Logic 130 may be hardwired to perform the one or more operations. Alternatively or additionally, logic 130 may be embodied in machine-executable instructions 132 stored in a memory, such as memory 106, to perform these operations. Alternatively or additionally, logic 130 may be embodied in firmware. Logic may be comprised in various components of system 100. Logic 130 may be used to perform various functions by various components as described herein.

Chipset 108 may comprise a host bridge/hub system that may couple each of processing cores 102A, 102B, 102C, 102D, and memory 106 to each other. Chipset 108 may comprise one or more integrated circuit chips, such as those selected from integrated circuit chipsets commercially available from Intel® Corporation (e.g., graphics, memory, and I/O controller hub chipsets), although other one or more integrated circuit chips may also, or alternatively, be used. According to an embodiment, chipset 108 may comprise an input/output control hub (ICH), and a memory control hub (MCH), although embodiments of the invention are not limited by this. Chipset 108 may communicate with memory 106 via memory bus 112 and with processing cores 102A, 102B, 102C, 102D via system bus 110. In alternative embodiments, processing cores 102A, 102B, 102C, 102D and memory 106 may be coupled directly to bus 106, rather than via chipset 108.

Processing cores 102A, 102B, 102C, 102D, memory 106, and busses 110, 112 may be comprised in a single circuit board, such as, for example, a system motherboard 118, but embodiments of the invention are not limited in this respect.

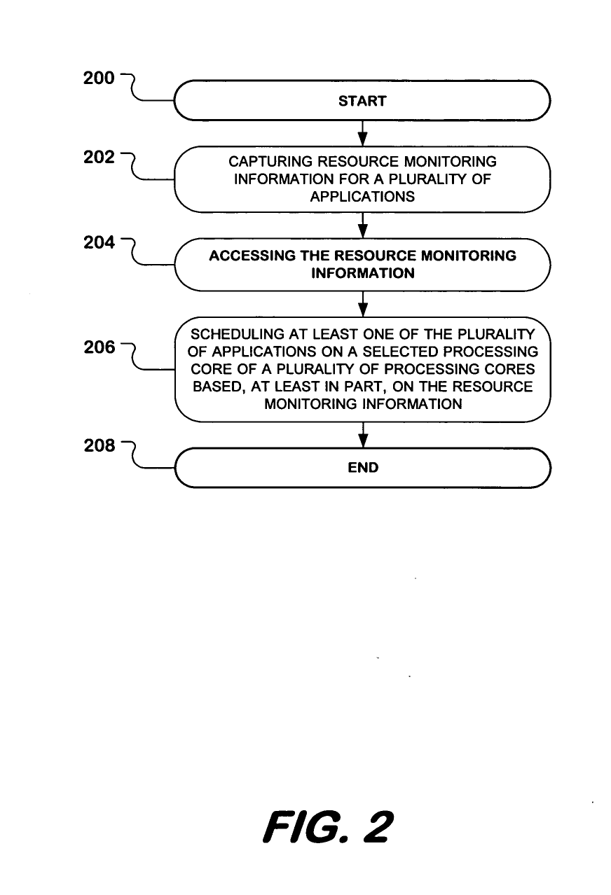

FIG. 2 illustrates a method in accordance with an embodiment of the invention. In an embodiment, the method of FIG. 2 may be implemented by a scheduler of an operating system, such as Windows® Operating System, available from Microsoft Corporation of Redmond, Wash., or Linux Operating System, available from Linux Online, located in Ogdensburg, N.Y.

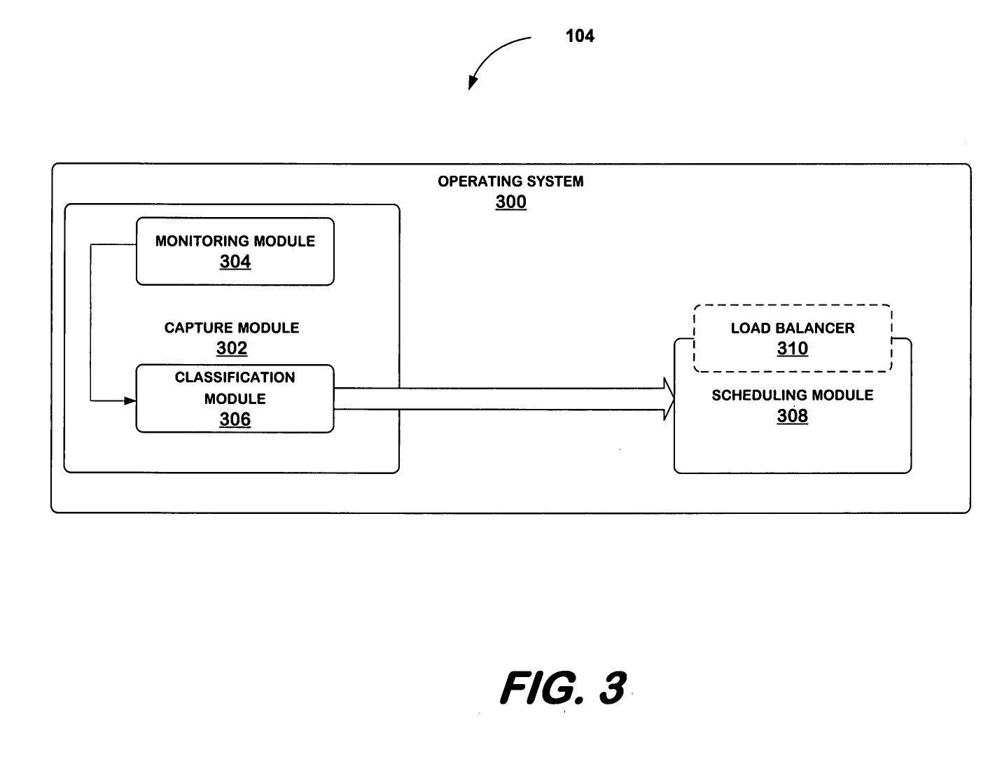

The method begins at block 200 and continues to block 202 where the method may comprise capturing resource monitoring information for a plurality of applications. Referring to FIG. 3, in an embodiment, block 202 may be carried out by a capture module 302 located in operating system 300 of memory 104.

As used herein, “resource monitoring information” relates to information about events associated with an application utilizing a resource. For example, in an embodiment, resource monitoring information may comprise resource usage information, where the resource may comprise, for example, a cache. In this example, the information associated with usage of the cache may include, for example, cache occupancy of a given application As used herein, “cache occupancy” of a particular application refers to an amount of space in a cache being used by the application.

In an embodiment, resource monitoring information may additionally, or alternatively, comprise contention information at a shared resource, where the resource may comprise, for example, a cache. In this example, the information associated with contention at the shared cache may comprise interference of a given application, or how often the application evicts another application's cache line with which it shares a cache. For example, when a cache is full, or its sets become full (e.g., which may depend on the cache line replacement scheme used in a particular system), a victim line is sought, evicted, and replaced with the new line. In an embodiment, the interference may be monitored on a per thread basis for each application.

Resource monitoring information may be captured by monitoring for specified events. In an embodiment, events may comprise cache occupancy and/or interference. For example, one way to capture cache occupancy and/or interference is to use software MIDs, or monitoring identities. In this method, cache lines are tagged with MIDs either when they are allocated, or when they are touched. Furthermore, to reduce the overhead of shared cache monitoring, and to avoid tagging every single line in the cache with MID, set sampling of the cache is used. This method is further described in “Cache Scouts: Fine-Grain Monitoring of Shared Caches in CMP Platforms”, by Li Zhao, Ravi Iyer, Ramesh Illikkal, Jaideep Moses, Srihari Makineni, and Don Newell, of Intel Corporation. Other methods not described herein may be used to capture resource monitoring information. In an embodiment, monitoring module 304 may capture the information.

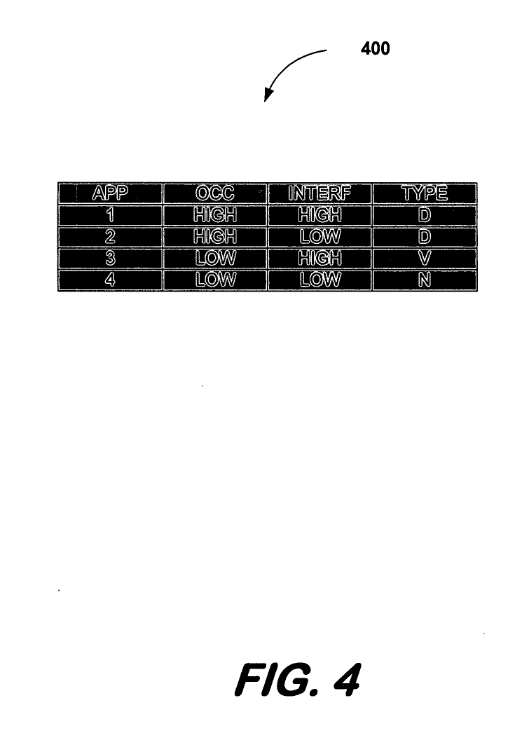

In an embodiment, the events may be sampled at specified intervals for each application running on the system. Furthermore, the resource monitoring information may be stored, for example, in a table. In an embodiment, as illustrated in FIG. 4, the table 400 may comprise an entry for each application. Each application may be associated with resource monitoring information, where the resource monitoring information may comprise one or more events (only two shown). For example, the events may comprise cache occupancy (OCC) and/or interference (INTERF) per thread.

In an embodiment, each application may be further associated with a type which refers to the classification of the application based, at least in part, on resource monitoring information.

In an embodiment, each application may be classified as V=Vulnerable; D=Destructive; N=Neutral. In an embodiment, a “destructive application” may comprise an application that occupies a cache with such frequency that it would not benefit from a larger cache. Alternatively, a destructive application may comprise an application that simply has a working set too large for the current amount of available cache capacity, and in this case, would benefit from a larger cache. Another characteristic of a destructive application is that it may end up kicking out another application's cache line due to its cache needs. An example of a destructive application is a streaming application. In the commonly used suite of applications for benchmarking in platform evaluation, Spec CPU 2000, the “Swim” and “Lucas” applications are examples of destructive applications. Spec CPU 2000 is available from SPEC (Standard Performance Evaluation Corporation), 6585 Merchant Place, Suite 100, Warrenton, Va., 20187.

A “neutral application” may comprise an application that may occupy a small portion of the cache, such that its performance does not change if you change the cache size. A neutral application may run with any other application without its performance being affected. Examples of neutral applications in the Spec CPU 2000 suite include “Eon” and “Gzip”.

A “vulnerable application” refers to an application where its performance may be affected by a destructive application. An example of a vulnerable application in the Spec CPU 2000 suite is “MCF”.

In embodiments of the invention, some applications may always be classified as only one of D, V, and N, regardless of what other applications with which it runs. For example, “Swim” and “Lucas” are examples of applications that are always destructive. In “Swim”, for example, the miss ratio does not change as a result of increasing the cache space from 512K to 16M. Its miss ratio remains almost flat.

Classification of other applications, however, may be dependent on what other applications with which it is running, and thus may be classified as one or more of D, V, or N at any given time. For example, a destructive application that needs substantial cache capacity may also be a vulnerable application because it gets hurt by others taking cache space away. An example of such an application is “MCF” and “ART” in Spec CPU 2000. These two applications have a large working set, and may end up being destructive in some cases. However, when one of these applications is run with another application that is always destructive, e.g., “Swim” or “Lucas”, it may end up being a vulnerable application. As another example, if “MCF” and “ART” are running on a processor together, they can be both destructive and vulnerable to each other at any given time.

While implementations may differ, and there may be various algorithms associated with each classification, as an example, table 400 illustrates that an application may be classified as destructive if its cache occupancy is high and interference per thread is high; destructive if its cache occupancy is low and interference per thread is high; vulnerable if its cache occupancy is high and its interference per thread is high; and N if its cache occupancy is low and interference per thread is low.

As another example, numbers or counts associated with the events may be combined (e.g., added with a 50/50 weight, or other weight distribution), and the applications in the table may be sorted. In an embodiment, as an example, the applications may be sorted in descending order, and applications at the top of the sorted order may be classified as D, and applications at the bottom of the sorted order may be classified as N. Applications that fall within a midrange, for example, a range that may be pre-specified, may be classified as V. Of course, embodiments of the invention are not limited in this respect.

For those applications that may be classified as more than one type, they may be sorted in accordance with their characteristics at the time of sampling, and classified accordingly. In embodiments of the invention, it is not necessary that an application be explicitly classified as D, V, or N; instead, applications at the top of the sorted order may be implicitly classified as D, and applications at the bottom of the sorted order may be implicitly classified as N, for example.

In an embodiment, monitoring module 304 may additionally store cache occupancy for a particular application on a per cache basis. For example, for each entry corresponding to an application, there may be an additional field for each cache, and a value representing occupancy of that cache by the corresponding application. Alternatively, where applications 114 are scheduled on a per-core queue basis, monitoring module 304 may store, for each application, cache occupancy on the shared cache 104A, 104B to which the processing core 102A, 102B, 102C, 102D is connected.

In an embodiment, monitoring module 304 may additionally store captured information in a table, and classification module 306 may classify the applications based on the resource monitoring information in accordance with the method described above.

At block 204, the method may comprise accessing the resource monitoring information. In an embodiment, the resource monitoring information may be accessed by accessing table 400. Alternatively, the resource monitoring information may be accessed by simply sampling captured data without storing the data in table 400.

At block 206, the method may comprise scheduling at least one of the plurality of applications on a selected processor of a plurality of processors based, at least in part, on the resource monitoring information. In an embodiment, scheduling module 308 may access the resource monitoring information, and then may schedule the applications 114 based on the resource monitoring information.

A “scheduling module”, as used herein, refers to a module that is used to schedule processing core time for each application or task. A scheduler, therefore, may be used to schedule applications on processing cores for the first time, or may be used to reschedule applications on a periodic basis.

In one embodiment, scheduling at least one application 114 based, at least in part, on the resource monitoring information may comprise scheduling the application 114 on a processing core 102A, 102B, 102C, 102D that is connected to one of the plurality of caches 104A, 104B having a high cache occupancy by the application 114. In this embodiment, for example, resource usage information may be captured for a plurality of applications 114, and then stored in a table 400.

For example, when an application 114 is about to be scheduled on a processing core 102A, 102B, 102C, 102D in system 100, scheduling module 308 may check the current cache occupancy of the application 114 in the various shared caches 104A, 104B. If the occupancy of the application 114 is high on a particular shared cache 104A, 104B, the application 114 may be scheduled on a processing core 102A, 102B, 102C, 102D that is connected to that shared cache 104A, 104B, if that processing core is free. For example, an application's 114 occupancy of a first cache 104A, for example, may be high if its occupancy on the first cache 104A is higher than occupancy on a second cache 104B, for example. Alternatively, where applications 114 are scheduled on a per-core queue basis, scheduling module 308 may look ahead in the per-core task queue to find an application 114 that has high cache occupancy. This may help to increase the hit rate on the shared cache 104A, 104B for that particular application 114 by, for example, scheduling the application before its data is displaced by other applications. Alternatively, the information may be used to migrate an application to another core if, for example, its cache occupancy has been reduced.

In another embodiment, scheduling at least one application based, at least in part, on the resource monitoring information may comprise pairing applications 114 without pairing a destructive application with a vulnerable application, and then scheduling the paired applications on one of the plurality of processors. In this embodiment, for example, both resource usage information and contention information may be captured for a plurality of applications, and then stored in a table.

For example, in this embodiment, resource monitoring information may be captured, stored, and sorted, based, at least in part, for example, on the sorted data. The applications 114 may then be classified based on the resource monitoring information. Furthermore, the applications 114 may be paired by not pairing a destructive application with a vulnerable application. For example, a destructive application may be paired with a destructive application; a destructive application may be paired with a neutral application; a neutral application may be paired with a neutral application; and a vulnerable application may be paired with a vulnerable application. The paired applications 114 may then be scheduled on one of the processors 102A, 102B, 102C, 102D.

Methods according to this embodiment may be performed by a load balancer 310 of a scheduling module 308 by enabling applications to be globally balanced across all processing cores. For example, in the Windows Operating System, a global load balancer may distribute applications across shared caches. In the Linux Operating System, for example, the optimization may enable the local load balancers (i.e., balancing the number of tasks on a per-core queue to be roughly equal) to balance on a shared cache basis.

In the foregoing specification, the invention has been described with reference to specific embodiments thereof. It will, however, be evident that various modifications and changes may be made to these embodiments without departing therefrom. The specification and drawings are, accordingly, to be regarded in an illustrative rather than a restrictive sense.

What is claimed is:

1. A method to schedule applications, comprising:
capturing resource monitoring information for a plurality of applications;
accessing the resource monitoring information; and
scheduling at least one of the plurality of applications on a selected processing core of a plurality of processing cores based, at least in part, on the resource monitoring information.

2. The method of claim 1, wherein the resource monitoring information comprises, for any given one of the plurality of applications, resource usage information.

3. The method of claim 2, wherein resource usage information comprises the application's occupancy of a given shared cache amongst a plurality of shared caches.

4. The method of claim 3, wherein said scheduling at least one of the plurality of applications on a selected processing core based, at least in part, on the resource monitoring information comprises scheduling the application on a processing core that is connected to one of the plurality of shared caches having a high cache occupancy by the application.

5. The method of claim 4, wherein said scheduling is performed on a per-core task queue.

6. The method of claim 4 wherein said scheduling is performed on a global shared cache basis.

7. The method of claim 1 additionally comprising classifying the plurality of applications based on the resource monitoring information.

8. The method of claim 7, wherein the resource monitoring information comprises resource usage information and contention information.

9. The method of claim 8, wherein said classifying the plurality of applications based on the resource monitoring information comprises classifying each of the applications into one of a vulnerable application, a destructive application, and a neutral application based on a combination of resource usage information and contention information.

10. The method of claim 9, wherein said scheduling at least one of the plurality of applications on a selected processing core based, at least in part, on the resource monitoring information comprises:
pairing applications without pairing a destructive application with a vulnerable application; and
scheduling the paired applications on one of the plurality of processing cores.

11. An apparatus to schedule applications, comprising:
a capture module having a monitoring module to monitor resource monitoring information for a plurality of applications; and
a scheduling module to:
use the monitored resource monitoring information; and
schedule at least one of the plurality of applications on a selected processing core of a plurality of processing cores based, at least in part, on the resource monitoring information.

12. The apparatus of claim 11, said capture module additionally comprising a classification module to classify the plurality of applications based on the resource monitoring information.

13. The apparatus of claim 12, wherein said classification module additionally classifies each of the applications into one of a vulnerable application, a destructive application, and a neutral application.

14. The apparatus of claim 11, wherein said scheduling module additionally:
pairs applications without pairing a destructive application with a vulnerable application; and
schedules the paired applications on one of the plurality of processing cores.

15. The apparatus of claim 14, wherein said scheduling module comprises a load balancer to pair applications and schedule the paired applications.

16. An article of manufacture having stored thereon instructions, the instructions when executed by a machine, result in the following:
capturing resource monitoring information for a plurality of applications;
accessing the resource monitoring information; and
scheduling at least one of the plurality of applications on a selected processing core of a plurality of processing cores based, at least in part, on the resource monitoring information.

17. The article of claim 16, wherein the resource monitoring information comprises, for any given one of the plurality of applications, resource usage information.

18. The article of claim 17, wherein resource usage information comprises the application's occupancy of a given shared cache amongst a plurality of shared caches.

19. The article of claim 18, wherein said scheduling at least one of the plurality of applications on a selected processing core based, at least in part, on the resource monitoring information comprises scheduling the application on a processing core that is connected to one of the plurality of shared caches having a high cache occupancy by the application.

20. The article of claim 19, wherein said scheduling is performed on a per-core task queue.

21. The article of claim 19, wherein said scheduling is performed on a global shared cache basis.

22. The article of claim 16 additionally comprising classifying the plurality of applications based on the resource monitoring information.

23. The article of claim 22, wherein the resource monitoring information comprises resource usage information and contention information.

24. The article of claim 23, wherein said classifying the plurality of applications based on the resource monitoring information comprises classifying each of the applications into one of a vulnerable application, a destructive application, and a neutral application based on a combination of resource usage information and contention information.

25. The article of claim 24, wherein said scheduling at least one of the plurality of applications on a selected processing core based, at least in part, on the resource monitoring information comprises:
pairing applications without pairing a destructive application with a vulnerable application; and
scheduling the paired applications on one of the plurality of processing cores.
